(19) United States
(12) Patent Application Publication
(10) Pub. No.: US 2016/0188633 A1
(43) Pub. Date: Jun. 30, 2016

(54) A METHOD AND APPARATUS FOR TRACKING MICROBLOG MESSAGES FOR RELEVANCY TO AN ENTITY IDENTIFIABLE BY AN ASSOCIATED TEXT AND AN IMAGE

(71) Applicant: NATIONAL UNIVERSITY OF SINGAPORE, Singapore (SG)

(72) Inventors: Fanglin Wang, Singapore (SG); Yue Gao, Singapore (SG); Huanbo Luan, Singapore (SG); Tat Seng Chua, Singapore (SG)

(73) Assignee: National University of Singapore, Singapore (SG)

(21) Appl. No.: 14/909,350

(22) PCT Filed: Jul. 31, 2014
(86) PCT No.: PCT/SG2014/000365

§ 371 Date: Feb. 1, 2016

Related U.S. Application Data
(60) Provisional application No. 61/861,190, filed on Aug. 1, 2013.

(51) Int. Cl. G06F 17/30; G06T 7/00

(52) U.S. Cl. CPC G06F 17/30253; G06T 7/0081; G06F 17/30684

(57) ABSTRACT

A method of tracking microblog messages for relevancy to an entity identifiable by an associated text and an image is disclosed. The method comprises (i) performing a search on the microblog messages based on the associated text to obtain a first set of results; (ii) performing image detection on the first set of results based on the associated image to obtain a set of seed messages; (iii) performing a search on the microblog messages based on a set of characteristics derived from the seed messages to obtain a second set of results; and (iv) selecting entries from the first and second sets of results based on relevancy to the entity, wherein the set of characteristics are associated to the entity. A related apparatus is also disclosed.

### FIELD

The present invention relates to a method and a related apparatus for tracking microblog messages for relevancy to an entity identifiable by an associated text and an image.

### BACKGROUND

Social media platforms [15, 17], such as Twitter™, Facebook™, or Sina Weibo™, have become ubiquitous and essential real-time information resources, with a wide range of users and applications. Consumers typically provide positive/negative comments when posting brand related information in the social media platforms, and such comments may spread quickly and widely across the entire social network. Knowledge and insights to the collective effect of the comments therefore have important societal and marketing values for enterprises and organisations [8, 12, 20], in terms of knowing about brand exposure and acceptance by consumers. Even for individual consumers, such insights are also extremely useful in helping to make purchase decisions far products of brands of interest to them. A rapidly increasing amount of live information in social media streams thus demand development of effective brand tracking techniques [7] for data gathering and media content analysis.

Hence, it is of no surprise that brand tracking from social media streams has begun to attract research attention in recent years [14, 21]. A main objective of brand tracking is to gather brand-related data from live social media streams. This is however not a traditional search task due to several unique properties of social media streams. Firstly, posts in social media platforms tend to be short and conversational in nature, and thus the contents/vocabularies used in the posts tend to change rapidly. Specifically, the traditional keyword-based data crawling methods [2, 4, 13] are limited in coverage of relevant data. Hence, using a fixed set of keywords is no longer able to guarantee the gather of a sufficiently representative set of social media data relevant to an entity (e.g. a brand/product). Secondly, an amount of social media data generated for a popular entity may be enormous. For instance, the Super Bowl blackout game in 2013 generated about 231,500 tweets per minute, and the game generated about 24 million tweets in total. Thirdly, the content of microblogs has become increasingly heterogeneous and multimedia in nature. Recent statistics show that about 30% of microblog posts include images (e.g. a study on 400 million tweets from Sina Weibo™ reveals that 27% of tweets contain images), and most of images do not include relevant text annotation (e.g. another study on 400,000 Sina Weibo™ tweets reveals only about 32% of tweets have images and associated texts with compatible meanings). Hence, using only a fixed set of keywords may not be sufficient for gathering of relevant data.

It is to be appreciated that existing solutions tend to focus mainly on the query expansion technique. Chen et al. [2] introduced a tweets gathering method, in which the keywords, candidate topics and popular topics are jointly employed for data gathering. Massoudi et al. [13] introduced a topic expansion technique to gather relevant data, in which query expansion is performed to generate dynamic topics for the target. Massoudi also introduced using quality indicators for microblog posts, i.e., reposts, followers, and recency, in which the indicators are combined to estimate a relevance probability of a microblog post. Similarly, Weerkamp and de Rijke [23] proposed a credibility framework to gather microblog posts. Sakaki et al. [18] proposed a real-time event information gathering for Twitter™, in which a large query set of the target event is employed for data crawling. In B. O'Connor et al. [16], an exploratory data gathering method, named TweetMotif, is proposed by using frequent keywords and subtopics. Zhou et al. [27] proposed to expand personalized queries for data gathering. Besides the target, the annotations and resources of a user are also taken into consideration for further data crawling. A tag-topic model is formulated in a latent graph to explore text data obtained from social media streams. Leung et al. [11] proposed to employ human judgment to generate semantic indexes. It is however worth noting that the above discussed solutions mainly rely on the text-based technique, but given the conversational and multimodal nature of modern social media streams, those methods are consequently limited in terms of coverage of relevant data.

One object of the present invention is therefore to address at least one of the problems of the prior art and/or to provide a choice that is useful in the art.

### SUMMARY

According to a 1^{st} aspect of the invention, there is provided a method of tracking microblog messages for relevancy to an entity identifiable by an associated text and an image. The method comprises (i) performing a search on the microblog messages based on the associated text to obtain a first set of results; (ii) performing image detection on the first set of results based on the associated image to obtain a set of seed messages; (iii) performing a search on the microblog messages based on a set of characteristics derived from the seed messages to obtain a second set of results; and (iv) selecting entries from the first and second sets of results based on relevancy to the entity, wherein the set of characteristics are associated to the entity.

The proposed method is advantageous in that data relevant/related to the entity (e.g. a brand) are gathered from microblog messages posted on social media platforms, by using evolving keywords, social factors (e.g. users, relations and locations) as well as visual contents. Thus by using the heterogeneous nature of data of social media content, more related and accurate data can beneficially be gathered. Moreover, noise filtering is also employed to filter noisy data from the returned results. Performance evaluations have shown that the proposed method achieves improved performance over conventional methods.

Preferably, the entity may include a brand or a product.

Preferably, performing the image detection may include: (i) dividing each image obtained from the first set of results into a plurality of sub-windows, and (ii) performing a sliding window search on the plurality of sub-windows to determine if the said image corresponds to the image associated with the entity.

Preferably, the set of characteristics may include social context-based data and image-based data. Further, the second set of results may include respective sets of results obtained based on the social context-based data and the image-based data. Specifically, the social context-based data may include information related to authors of the seed messages, users associated with the seed messages or the authors of the seed messages, users who have commented on the seed messages, users with corresponding user identities having the associated text, and geographical locations from where the seed messages were posted.

Also, performing the search on the microblog messages may preferably include performing a text-based search using the associated text.

Preferably, selecting entries from the first and second sets of results may include: (i) constructing a hypergraph to determine correlations among microblog messages in the first and second sets of results to obtained associated correlation results; (ii) determining respective scores for said microblog messages based on the correlation results; and (iii) ranking said microblog messages based on the respective scores.

According to a 2^{nd} aspect of the invention, there is provided an apparatus for tracking microblog messages for relevancy to an entity identifiable by an associated text and an image. The apparatus comprises a processor module adapted to: perform a search on the microblog messages based on the associated text to obtain a first set of results; perform image detection on the first set of results based on the associated image to obtain a set of seed messages; and perform a search on the microblog messages based on a set of characteristics derived from the seed messages to obtain a second set of results; and a selection module for selecting entries from the first and second sets of results based on relevancy to the entity, wherein the set of characteristics are associated to the entity.

It should be apparent that features relating to one aspect of the invention may also be applicable to the other aspects of the invention.

These and other aspects of the invention will be apparent from and elucidated with reference to the embodiments described hereinafter.

### BRIEF DESCRIPTION OF THE DRAWINGS

Embodiments of the invention are disclosed hereinafter with reference to the accompanying drawings, in which:

FIG. 1 is a flow diagram of a method of tracking microblog messages for relevancy to an entity identifiable by an associated text and an image, according to an embodiment;

FIG. 2 is a flow diagram elaborating on steps of FIG. 1;

FIG. 3 shows an image detection method used by the method of FIG. 1 to detect images related to the entity in the microblog messages;

FIG. 4 includes FIG. 4a and FIG. 4b, which are respective flow diagrams of a training process and a detection process of the image detection method of FIG. 3;

FIG. 5 includes FIG. 5a and FIG. 5b, which depict example illustrations of extended data gathering adopted by the method of FIG. 1 via social context using key users and known locations respectively;

FIG. 6 depicts an illustration of extended data gathering of the method of FIG. 1 using visual content;

FIG. 7 shows a pictorial overview of a noisy data filtering method used in the method of FIG. 1;

FIG. 8 illustrates an aggregated set of candidate microblogs gathered, which is to be processed by the noise removal method of FIG. 7;

FIG. 9 is a flow diagram of the noisy data filtering method of FIG. 7;

FIG. 10 includes FIGS. 10a and 10b, which depict examples of microblog hypergraphs construed via text-based hyperedges and visual-based hyperedges respectively;

FIG. 11 shows the Brand-Social-Net dataset used for evaluating the method of FIG. 1;

FIG. 12 includes FIGS. 12a to 12c depicting metrics of distributions for brands/products collected in the Brand-Social-Net dataset of FIG. 11;

FIG. 13 shows event details resulting in generation of data for the brand/products collected in the Brand-Social-Net dataset of FIG. 11;

FIG. 14 is a table comparing data coverage results of various data gathering methods evaluated; and

FIG. 15 includes FIGS. 15a and 15b which depict performance results of the data gathering methods evaluated.

### DETAILED DESCRIPTION OF PREFERRED EMBODIMENTS

### 1. Brand Data Gathering in Social Media Streams

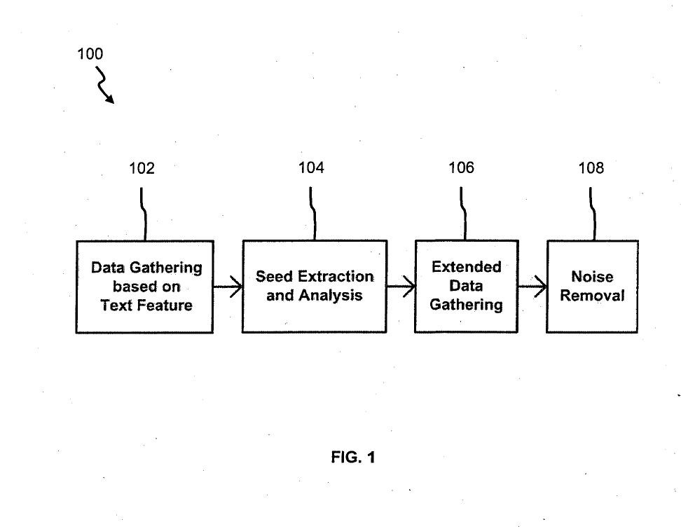

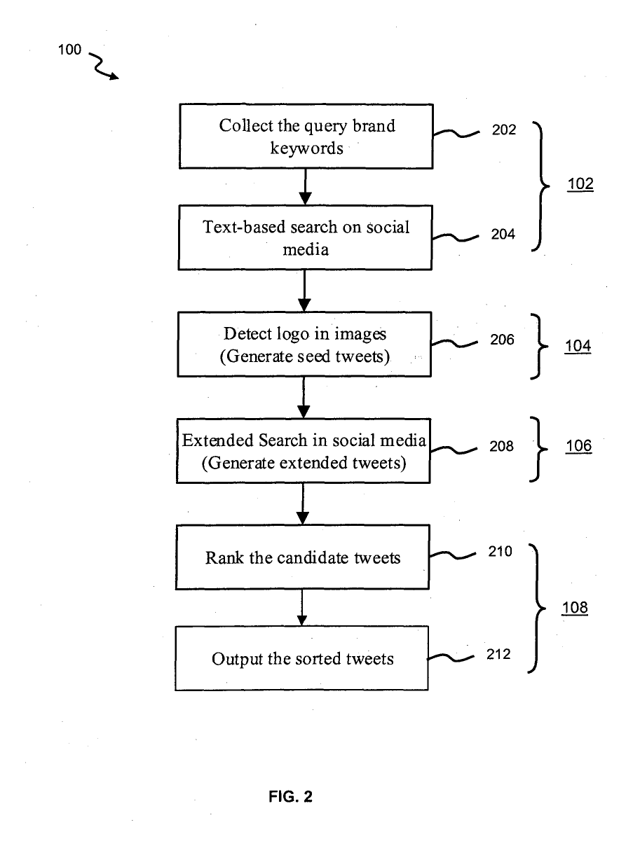

A proposed method 100 for tracking microblog messages/posts for relevancy to an entity identifiable by an associated text and an image is disclosed, according to an embodiment shown in a flow diagram of FIG. 1. FIG. 2 is another flow diagram which elaborates on certain steps of FIG. 1. To clarify, the microblog messages/posts are received from social media streams (e.g. Sina Weibo™) For brevity, the microblog messages/posts are referred to as microblogs hereafter, but not to be construed as limiting. An example of an entity is a target brand (i.e. 8) of particular interest to consumers/organisations, and description of the method 100 hereafter is with reference to the target brand, but similarly not to be construed as limiting in any respect (e.g. the entity may also be a product alternatively).

From FIG. 1, the method 100 comprises four sequential stages, i.e. a “data gathering based on text feature” stage 102 (hereafter data gathering stage), a “seed extraction and analysis” stage 104 (hereafter seed gathering stage), an “extended data gathering” stage 106, and a “noisy data filtering” stage 108 (hereafter noise filtering stage). Referring to FIG. 2, the data gathering stage 102 includes first collecting specific query keywords related to the target brand at step 202, and using the collected keywords to search a given designated dataset of microblogs (i.e. target set) at next step 204 to obtain a set of text-based results (i.e. [symbol] ^{t}). It is to be appreciated that the target set includes microblogs obtained and collected from various social media streams. So, the data gathering stage 102 is arranged to perform a text-based search to obtain the text-based results [symbol] ^{t}. Using the text-based results [symbol] ^{t}, a seed set of microblogs (i.e. seed microblogs) is generated by detecting an image (e.g. a logo) associated to the target brand at further step 206, being the seed gathering stage 104. The seed set and seed microblogs will be referred to interchangeably hereafter. Specifically, at the step 206, both text and visual content relating to the target brand are analysed to obtain the seed microblogs that are relevant from both text and visual perspectives. As a result, the seed microblogs are considered highly relevant to the target brand, and consequently used to search for more related data via social-context (e.g. active users and known locations) and visual-context aspects of the target brand. Using data relating to the social-context and visual-context aspects as a basis, an extended data search is further performed on the target set at step 208 (i.e. the “extended data gathering” stage 106) to obtain a set of social context-based results (i.e. [symbol] ^{c}) and a set of visual content-based results (i.e. [symbol] ^{ν}). The text-based results [symbol] ^{t}, social context-based results [symbol] ^{c} and visual content-based results [symbol] ^{ν} are collectively denoted as an aggregated set (i.e. [symbol] ) of candidate microblogs relevant to the target brand. Hence, the method 100 may also be termed as a multi-faceted brand tracking method.

It is to be appreciated that while the aggregated set [symbol] gathered using the multifaceted approach include a large representative set of relevant microblogs relating to the target brand, a lot of irrelevant microblogs are however also included as well. So to address this issue, the proposed method 100 is also arranged to analyse the aggregated set [symbol] to filter and remove the irrelevant microblogs at the noise filtering stage 108. Specifically, the microblogs in the aggregated set [symbol] are ranked and then sorted at steps 210 and 212 respectively. As the aggregated set [symbol] include multimodal data (e.g. text, images, locations, user data and etc.), a multimodal hypergraph based approach (based on supervised learning) is used for the noise filtering.

More information for the four mentioned respective stages 102, 104, 106, 108 of the method 100 (shown in FIG. 1) are further described below.

### 1.1 Data Gathering Based on Text Feature

For tracking of the target brand, the text-based search under the data gathering stage 102 is first performed to generate the text-based results [symbol] ^{t} for the target brand. In this embodiment, related query keywords (e.g. the brand name and/or corresponding product names) are used to search the target set for microblogs related to the target brand. For example, given a brand “Volkswagen”, besides the brand name itself, related keywords may include the product names related to “Volkswagen”, e.g. “Jetta” and “Magotan”, and/or other extended keywords, such as “car” and “engine”. It is also to be appreciated that if the social media streams support multiple languages, suitable translations of the keywords in the respective languages may be used in the text-based search too.

### 1.2 Seed Gathering and Analysis

It is to be appreciated that data gathering using keywords related to the target brand (at the data gathering stage 102) tend to also include a lot of noisy data (i.e. unrelated data), because presence of names of the target brand does not necessarily guarantee relevance of the microblogs. So, other aspects of the microblogs need to be also examined to remove the noisy data. In this regard, it is observed that many microblogs increasingly tend to also include image(s), and so the image content aspect may be leveraged to find a subset of relevant microblogs (i.e. the seed microblogs) that have high relevance to the target brand, in terms of both text and visual contents perspective. Locating the seed microblogs is done at the seed gathering stage 104, in which a representative logo of the target brand is used as a discriminative visual feature as the image to be detected in the target set. Given the text-based results [symbol] ^{t}={ [symbol] ^{t}^{_{w}}, [symbol] ^{t}^{ₒ}}, [symbol] ^{t}^{_{w}}={m₁^{t}^{_{w}}, m₂^{t}^{_{w}}, . . . , mₙ_{_{w}}^{t}^{_{w}}} represent the n_{w} microblogs with images, whereas the nₒ microblogs without images are represented as [symbol] ^{t}^{ₒ}={m₁^{t}^{ₒ}, m₂^{t}^{ₒ}, . . . , mₙ_{ₒ}^{t}^{ₒ}}. For [symbol] ^{t}^{_{w}}, then let [symbol] ^{t}={ [symbol] ₁^{t}, [symbol] ₂^{t}, . . . , [symbol] ₙ_{_{w}}^{t}} denote the corresponding n_{w} images.

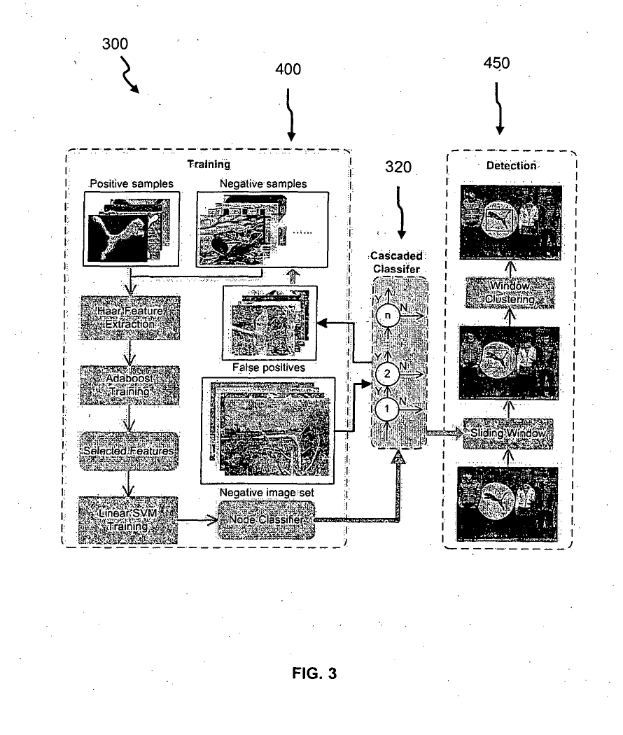

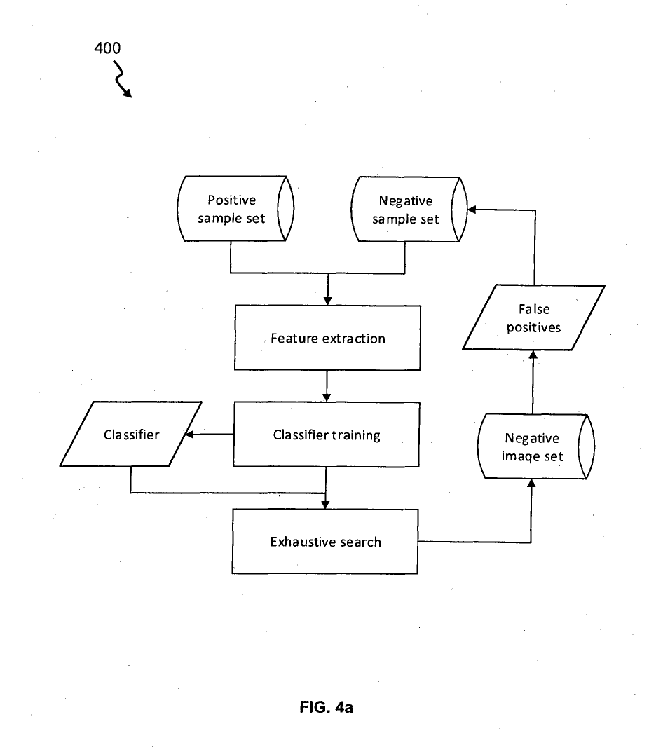

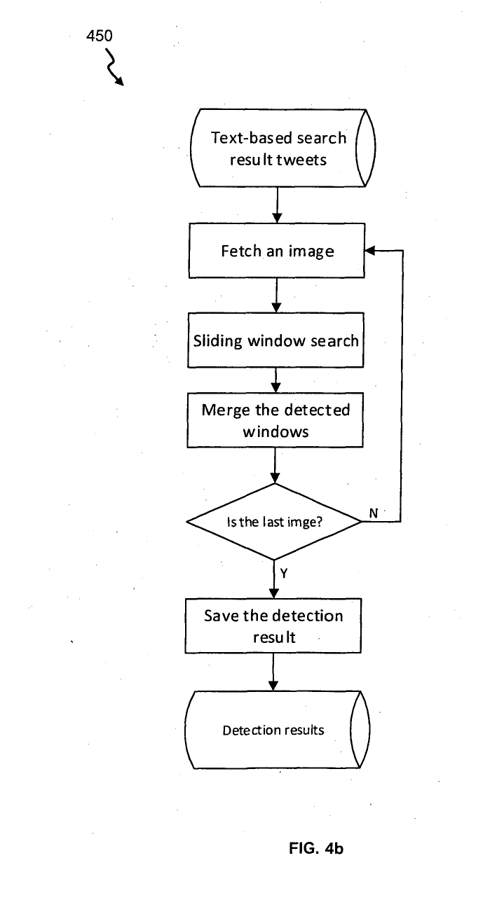

FIG. 3 shows an overview of an image detection method 300 used at the seed gathering stage 104, while FIG. 4a and FIG. 4b show respective flow diagrams of a training process 400 and a detection process 450 of the said image detection method 300. It is to be appreciated that the aim of the image detection is to detect the said logo of the target brand in each image Iᵢ^{t}ε [symbol] ^{t} in the text-based results [symbol] ^{t}. Specifically, a cascaded classifier 320 is employed in the image detection method 300, and is jointly trained using Adaboost and SVM [3]. Prior to performing the image detection, the training process 400 is first carried out. In the training process 400, a set of positive sample images (determined to be related to the target brand) is collected from (e.g.) Google Image and Flickr, and then manually labelled. The positive sample images include specified fractions and image patches in which the said logo of the target brand is present therein. A set of negative sample images which do not include said logo of the target brand is also collected from Google Image and Flickr to provide an initial negative sample set and false positives. In this instance, “false positives” refer to negative sample images that are falsely classified as positive. It is also to be appreciated that the set of positive sample images is fixed and remains unchanged during the training process 400, whereas the set of negative sample images is recursively added with new images (to be explained below).

It is to be highlighted that the training process 400 employed is recursive in nature, as set out in [22], by building the cascaded classifier 320 comprising multiple node classifiers, until a satisfactory performance is attained. At each round of the training process 400, visual features are extracted from both the positive and negative sample images, and provided to a learning process (within the image detection method 300) to train a specific classifier. The extracted visual features include, but not limited to any or combination of, Harr features [22], HOG [3], dense LBP [28], SIFT [31], and SURF [32]. But for this embodiment, Harr features are used. Also, the cascaded classifier 320 adopted may be SVM (i.e. Support Vector Machines), Adaboost, or Random Forest [29]. Specifically, at each round of the training process 400, Adaboost (for example) is used to select a plurality of Harr features, but different to [22], a final node classifier is instead a linear SVM learnt by via the selected Harr features, based on the current set of positive and negative samples used for the training. Each node classifier is then sequentially concatenated (on conclusion of the current training round) to form the cascaded classifier 320, which is arranged to further exhaustively search within the negative sample images for any false positives. The newly obtained false positives are consequently included as part of the present set of negative sample images. Further subsequent rounds of the training process 400 are accordingly performed in the same manner described above, until a satisfactory performance is reached (i.e. a rate of false positive is considered sufficiently low), and the training process 400 is then terminated.

For clarity, it is to be appreciated that the rate of false positive rate is defined as a percentage of images in the negative sample images determined as false positives, and in this instance, the definition of “sufficiently low” means that the rate of false positive rate reaches about 5% (which is empirically chosen, but not however to be construed as limiting as other suitable values may also be selected based on applications). Thus, if the negative sample images include a total of 2000 images, and consequently, if 100 images are determined as false positives, then the rate of false positive is considered “sufficiently low”.

The detection process 450 is then performed on the text-based results [symbol] ^{t}. For the detection process 450, to determine whether a candidate image is relevant to the said logo of the target brand, the candidate image is retrieved and divided into multiple sub-windows at multiple scales. A sliding window search method, with one pixel stride on both the x and y directions of the candidate image, is then used for scanning the multiple sub-windows. It is to be appreciated that a number of scales used and sub-windows to be divided into are empirically configured to achieve an optimal balance between detection performance and detection speed. Thereafter, sub-windows classified as positive are then clustered (according to location and size) to provide a final result representing detection of said logo of the target brand. In this instance, clustering of the sub-windows includes a reference to using the mean-shift, and non-maximal suppression techniques. If there is no detection of said logo of the target brand, the sub-windows are conversely classified as negative. It is to be appreciated that for actual implementation, a training template used is arranged to be of a small size of, for example 24×18 pixels for the Puma logo. In practice, it is to be appreciated that as each node classifier of the cascaded classifier 320 is able to eliminate a large amount of sub-windows considered negative, the detection process 450 is thus executed fairly quickly.

Based on the detection, all images in microblogs of the text-based results [symbol] ^{t} are then tagged as with or without the said logo (of the target brand) using a property L. For the i-th image Iᵢ^{t}ε [symbol] ^{t}, wherein if the i-th image is detected with the logo of the target brand, then a condition of [symbol] ᵢ^{t}=1 is set; otherwise a condition of [symbol] ᵢ^{t}=0 is set. Indeed, microblogs in the text-based results [symbol] ^{t} determined to include relevant text associated with the target brand and also detected to have images with the property of [symbol] ᵢ^{t}=1 are thus highly likely to be relevant to the target brand and consequently included into the seed set (as the seed microblogs).

### 1.3 Extended Data Gathering

As set out, the text-based results [symbol] ^{t} are obtained at the data gathering stage 102. To further explore the heterogeneous nature of data present in social media streams, the method 100 of FIG. 1 also includes extended data gathering on the target set to locate more related microblogs beyond the scope of text-based search. Specifically, this is performed at the extended data gathering stage 106, in which both social context and visual content aspects of the seed microblogs are employed (to be elaborated below).

### 1.3.1 Social Context

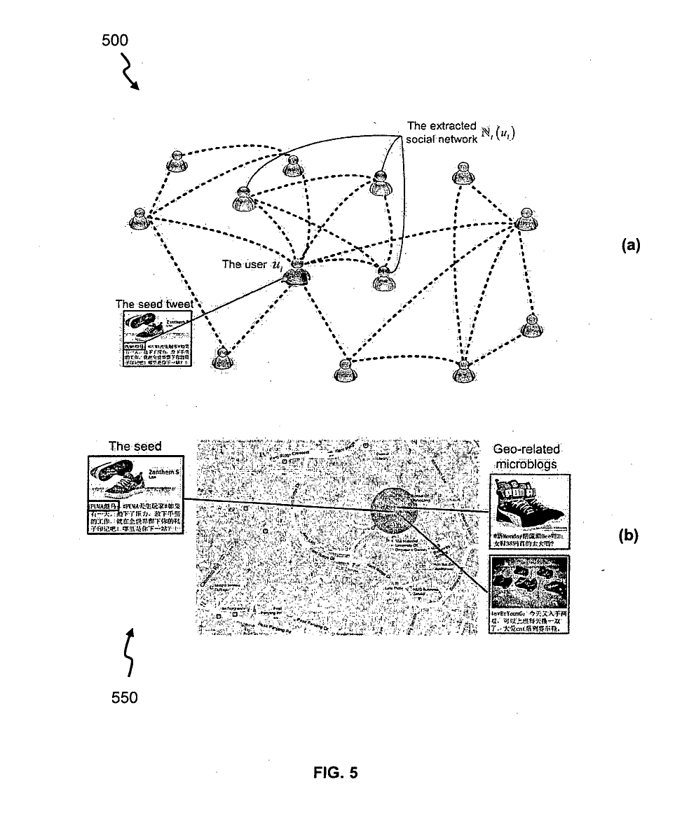

In social media platforms, social context covers the social aspect of microblogs, such as user name, time of posting of the microblogs, location from which the microblogs are posted, user comments (if any), re-posting activities (if any), relationships between users and etc. So, the proposed method 100 is arranged to search for accurate social context from the seed set for further gathering of data (from the target set) relevant to the target brand. Specifically for this embodiment, two types of extended information relating to social context are of particular interest, i.e. key users and known locations to be extracted from the seed set, where FIGS. 5a and 5b show example illustrations 500, 550 of extended data gathering via social context using key users and known locations respectively.

### 1.3.1.1 the Key Users

The key users are defined as users who are considered active and influential with respect to the target brand. Two groups of key users are considered: (1) authors of the seed microblogs and (2) users who have commented on the seed microblogs. The said two groups of users are highly related to the seed microblogs, and thus are considered highly likely to post relevant microblogs again within a first predetermined time period. For each author uᵢ of a seed microblog, a time-constraint social network [symbol] ₜ (uᵢ) is extracted from the social connections [symbol] (uᵢ) associated with each author uᵢ, and all the microblogs in [symbol] ₜ (uᵢ) are chosen as candidates. For the users who have made comments, microblogs from those users are also returned as the candidates.

### 1.3.1.2 Known Locations

From the seed microblogs, possible geo-locations associated with a high number of relevant seed microblogs are to be identified. Such geo-locations typically indicate places with activities related/relevant to the target brand, such as product launch, exhibition, and etc. Therefore, other microblogs in the target set originating from the identified locations within the predetermined time period are potentially relevant to the target brand too. Hence all microblogs (in the target set) originating from/nearby to the identified locations are gathered and filtered by posting time as a possible relevant set.

It is to be appreciated that in this instance a threshold of the first predetermined time period for data selection is set to one day. By using the social context of the seed microblogs, the social context-based results are obtained after a search conducted on the target set, and denoted as [symbol] ^{c}={m₁^{c}, m₂^{c}, . . . , mₙ_{_{c}}^{c}}.

### 1.3.2 Visual Content

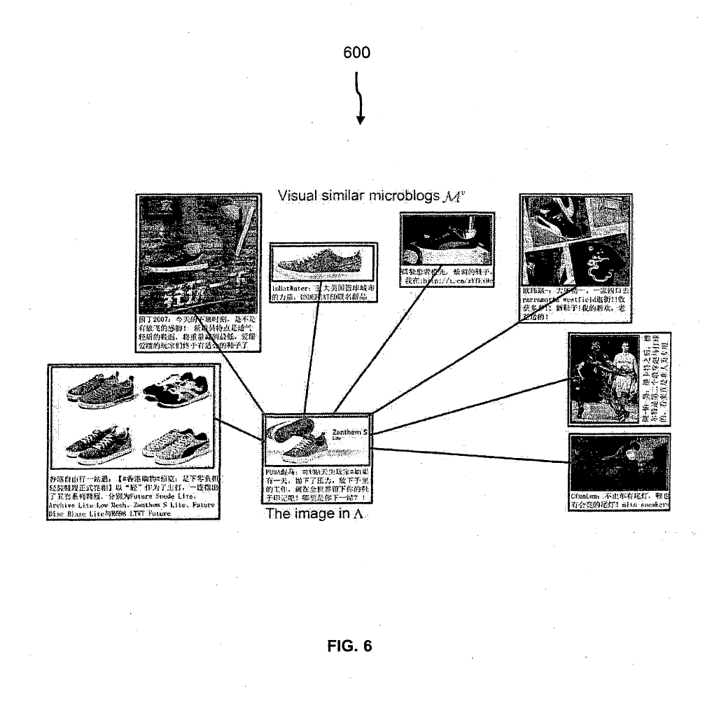

Visual content of microblogs is another aspect that is important, which increasingly has impact in social media streams. Similar visual content between two given images may indicate close semantics in the corresponding microblogs, in which the said two images are included. Here, the visual content of the seed microblogs is used as another basis to locate further microblogs from the target set that may potentially be relevant to the target brand. FIG. 6 shows an example illustration 600 of extended data gathering by using visual content. As many duplicate images are generated by re-posting in social media platforms, seed image clustering is first performed to generate a group of unique images, [symbol] , for the extended data gathering. Specifically, the hierarchical agglomerative clustering (HAC) method [19] is employed for the seed image clustering.

Next, the images in [symbol] are compared with images posted in the target set within the first predetermined time period. For simplicity, only a subset of images that are determined to be within the top k closest images in [symbol] are considered. Due to a high volume of data in social media streams, the set of images in the target set to be compared with the images in set [symbol] is large, typically involving close to about millions of images. So for efficiency considerations, an efficient microblog image indexing system (not shown) is specifically devised to achieve fast image matching. In the said image indexing system, a spatial pyramid image feature [25] is extracted for each image to be compared (which include images in [symbol] and the target set), which is highly discriminative on spatial layout and local information. Specifically, a dense sift feature is extracted for each image. A visual dictionary of size 1024 is learnt by sparse coding, and a spatial pyramid feature is generated by multi-scale max pooling. The spatial pyramid feature is structured to include three levels and a 21504-D feature is generated for each image. A 32-bit Hash code is further generated for each image using spectral hashing [24]. Thereafter, a 200-D feature is extracted using PCA for post-processing.

Now, given an image from [symbol] , the image indexing system first returns a set of results via using the 32-bit Hash code. The returned results are then refined using the obtained PCA features. Finally, the refined results are ranked in terms of relevance to the images in [symbol] and the top nᵢ images are returned. So, the visual content-based results obtained are denoted as [symbol] ^{ν}={m₁^{ν}, m₂^{ν}, . . . , mₙ_{_{ν}}^{ν}}.

### 1.4 Noisy Data Removal

To recall, at the data gathering stage 102, seed gathering stage 104, and extended data gathering stage 106, the following types of microblog candidates deemed relevant to the target brand are collected, i.e. the text-based results [symbol] ^{t}, the social context-based results [symbol] ^{c}, and the visual content-based results [symbol] ^{ν} (which are all grouped as the aggregated set [symbol] ). However, use of the extended data gathering also undesirably includes a lot of noisy data (i.e. unrelated information), which are unwanted. So at the noise filtering stage 108, both the text information and visual content aspects (of all the microblogs in the target set) are simultaneously investigated to explore relevance of microblogs in the aggregated set [symbol] , with respect to the target brand for filtering and removing the noisy data.

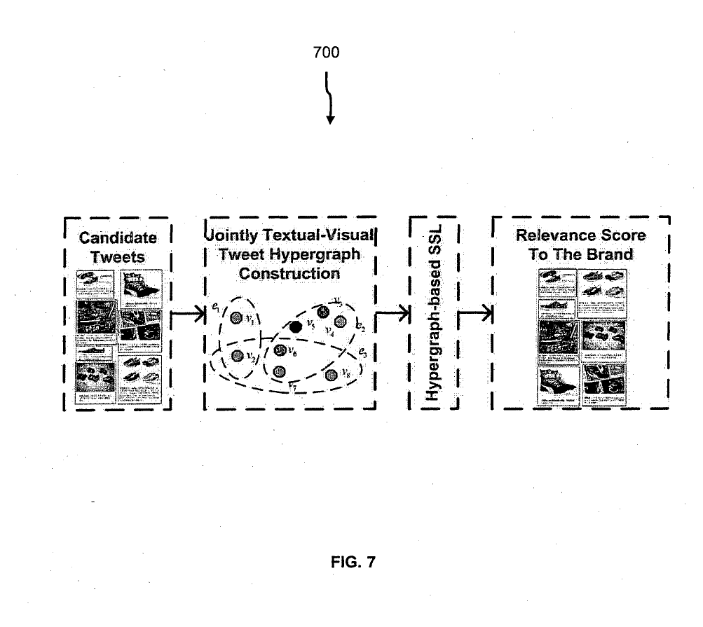

To derive a formulated relationship among the microblogs in the aggregated set [symbol] , a hypergraph structure is employed in this instance. It is to be appreciated that Hypergraph [26] is typically employed for many types of data mining and information retrieval tasks [1, 5, 6, 9] due to its superior performance for high-order relationship modelling. In constructing the hypergraph, a semi-supervised learning process is adopted for noisy data filtering, and FIG. 7 shows a pictorial overview of a noisy data filtering method 700 used in this embodiment.

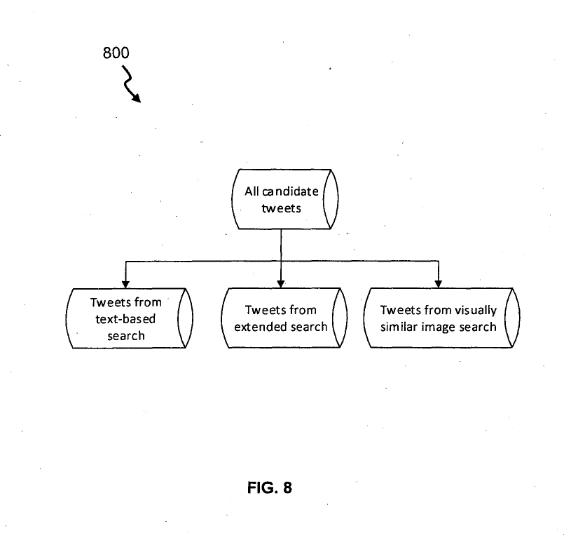

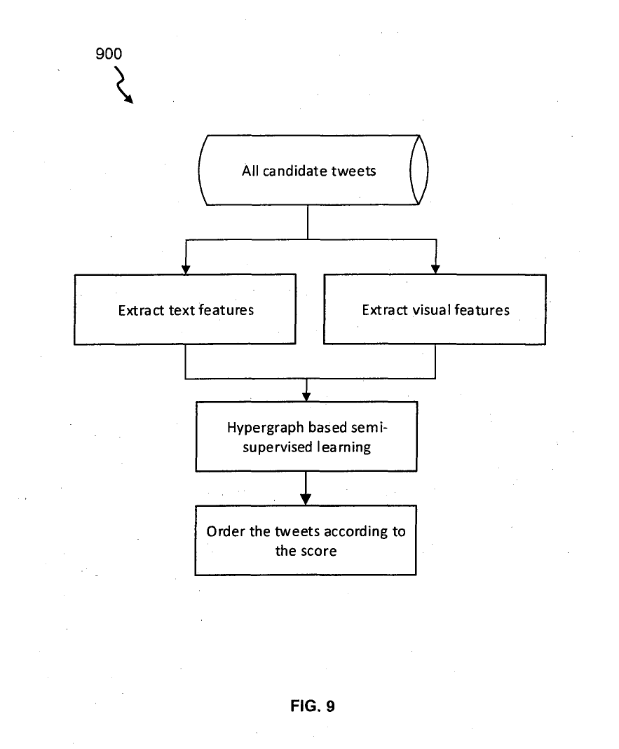

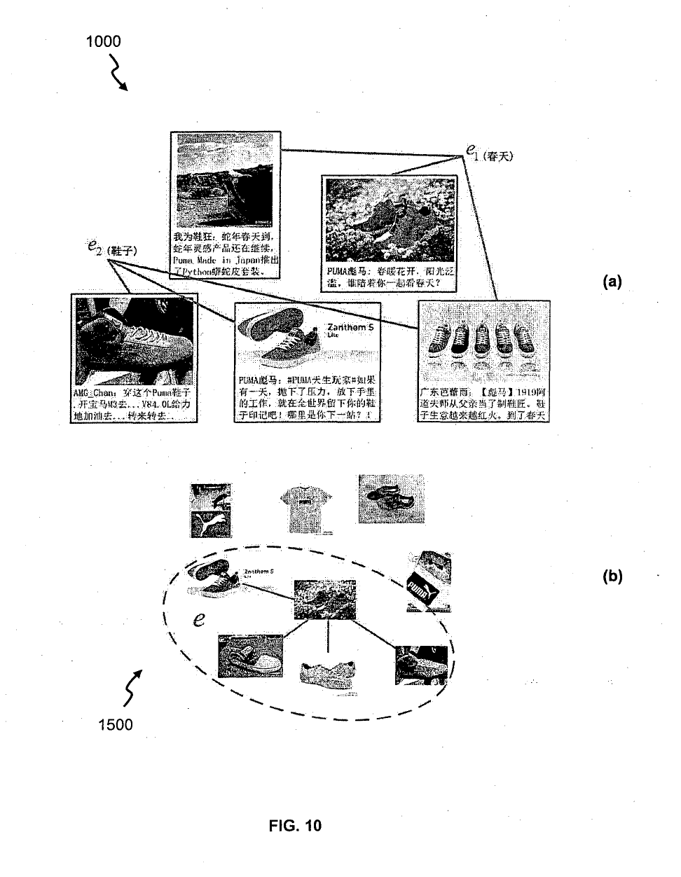

Now, let [symbol] ={ [symbol] ^{t}, [symbol] ^{c}, [symbol] ^{ν}}={m₁, m₂, . . . , mₙ} denote the aggregated set of n candidate microblogs (i.e. see illustration 800 in FIG. 8). FIG. 9 then shows an overview of a flow diagram 900 of the noisy data filtering method 700. A microblog hypergraph [symbol] ={ [symbol] , ε, W} is then constructed using all the microblogs in the aggregated set [symbol] . In the microblog hypergraph [symbol] , each vertex νε [symbol] denotes one microblog found in the aggregated set [symbol] . To investigate correlation among the microblogs in the aggregated set [symbol] , two types of hyperedges ε are constructed, i.e. text-based hyperedge εₜₑₓₜ and visual feature-based hyperedge εᵥᵢₛᵤₐₗ (as respectively depicted in example illustrations 1000, 1500 in FIGS. 10a and 10b).

For the text-based hyperedges εₜₑₓₜ, parsing is performed on the text context of each microblog, and with a learnt codebook Dₜₑₓₜ, each word in the said text content is encoded into a code. It is to be appreciated that only words with an occurrence frequency of above a predetermined threshold s (i.e. s=10 in this instance) are used for generating the text-based hyperedges εₜₑₓₜ. For example, a top 200 words with highest frequency may be removed, and the next highest ranked 2000 words are instead employed for generating the text-based hyperedges εₜₑₓₜ. Each microblog mᵢ (in the aggregated set [symbol] ) is represented by an n_{c1}×1 feature vector fᵢ^{text}, where fᵢ^{text}(k,1)=1 indicates that the specific microblog mᵢ contains the k-th word in the said codebook Dₜₑₓₜ. Each selected word generates an associated text-based hyperedge εₜₑₓₜ, from which the microblogs in the aggregated set M that contain that word (i.e. fᵢ^{text}(k,1)=1) are connected. Accordingly, there are n_{c1} text-based hyperedges εₜₑₓₜ in total.

For the visual content aspect, the star-expansion method is employed to investigate the relevance among different microblog images. Each image is regarded and set as a center image, from which the top k nearest neighbour images are connected to and this generates one visual hyperedge εᵥᵢₛᵤₐₗ. In this instance, the value of k is set to five. It is to be appreciated that there are n_{c2} visual feature-based hyperedges εᵥᵢₛᵤₐₗ which are equal to a number of images in the aggregated set [symbol] to be processed. Altogether, there are thus n_{c1}+n_{c2} visual feature-based hyperedges εᵥᵢₛᵤₐₗ for the microblog hypergraph [symbol] .

It is highlighted that the symbol “W” hereafter represents a diagonal matrix of the weights of the visual feature-based hyperedges εᵥᵢₛᵤₐₗ. For each hyperedge eᵢεε, the associated weight is set as

$$w ( {e}_{i} ) = \frac{1}{{n}_{c 1}} and w ( {e}_{i} ) = \frac{1}{{n}_{c 2}}$$

for the text-based and the visual-feature based hyperedges εₜₑₓₜ, εᵥᵢₛᵤₐₗ respectively. An incidence matrix H of the microblog hypergraph [symbol] is expressed as equation (1):

$$H ( v , e ) = \{ \begin{matrix}1 & if v ∈ e \\ 0 & if v ∉ e\end{matrix} \qquad ( 1 )$$

A vertex degree of a vertex νε [symbol] is defined in equation (2) as:

$$d ( v ) = {\sum }_{c ∈ ɛ} w ( e ) H ( v , e ) \qquad ( 2 )$$

An edge degree of the hyperedge eεε is defined in equation (3) as:

$$δ ( e ) = {\sum }_{v ∈ V} H ( v , e ) \qquad ( 3 )$$

Two diagonal matrices D_{ν} and Dₑ corresponding to d(ν) and δ(e) respectively are defined as D_{ν} (i, i)=d(νᵢ) and D_{ν} (i, i)=δ(eᵢ).

It is to be appreciated that the objective is to explore the correlation among all microblogs (in the aggregated set [symbol] ) using the microblog hypergraph [symbol] . A semi-supervised learning procedure is then conducted on the microblog hypergraph [symbol] to minimize the empirical loss and the regularizer on the hypergraph structure [symbol] simultaneously by satisfying a condition:

$$arg {min}_{R} \{ Ψ + λΓ \} \qquad ( 4 )$$

wherein λ is a trade-off parameter, R is an to-be-estimated relevance vector of all microblogs to the target brand (i.e. to clarify, R is a vector including a plurality of relevance values. For example, if there are 100 microblogs in total, R then includes 100 relevance values of the respective 100 microblogs), while Y hereafter is the labelled vector by relevance estimation results in the text-based results [symbol] ^{t}, and ψ defined in equation (5) is the regularizer on the hypergraph structure [symbol] :

$$( 5 )$$

$$\begin{matrix}Ψ = \frac{1}{2} {\sum }_{e ∈ ɛ} {\sum }_{u , v ∈ V} \frac{w ( e ) h ( u , e ) h ( v , e )}{δ ( e )} {( \frac{R ( u )}{\sqrt{{D}_{v} ( u , u )}} - \frac{R ( v )}{\sqrt{{D}_{v} ( v , v )}} )}^{2} \\ = {R}^{T} ( I - {D}_{v}^{- \frac{1}{2}} {HWD}_{e}^{- 1} {H}^{T} {D}_{v}^{- \frac{1}{2}} ) R\end{matrix}$$

and Gdefined in equation (6) is the empirical loss:

Γ=∥R−Y∥² (6)

In this instance, let Δ=I−D_{ν}^{-1/2}HWDₑ⁻¹H^{T}D_{ν}^{-1/2}, and a solution for the above objective function is obtainable by (as per equation (7)):

$$R = {( I + \frac{1}{λ} Δ )}^{- 1} Y \qquad ( 7 )$$

Beneficially, by using a relevance score computed based on the relevance vector R, all microblogs in in the aggregated set [symbol] can be ranked. The top results of microblogs with high relevance scores are then determined as being relevant to the target brand. For example, a microblog with a relevance value of 0.9 (i.e. high relevance score) is ranked at a higher position versus another microblog with a relevance value of 0.3 (i.e. low relevance score).

With the proposed method 100, as many microblogs as possible related to the target brand are collected, and then ranked appropriately to reflect current social exposure of the target brand and related opinions of users/consumers. This is advantageous in two ways: (1). From the text information and visual content aspects, both the social context and visual information are used to cover more relevant microblogs that are considered potentially related/relevant to the target brand. Conventional methods in contrast use only mainly text information and thus frequently omit many relevant microblogs, while also often producing wrong results. (2). By combining the text information and visual content, ranking of the microblogs will reasonably be more accurate because microblogs more relevant are to the target brand are likely to be ranked higher. As a comparison, it is to be appreciated that current social media platforms do not provide such a ranking functionality.

For good order, it is also to be appreciated that the proposed method 100 of FIG. 1 may be realised in the form of an apparatus (not shown) for tracking microblogs for relevancy to an entity (e.g. the target brand) identifiable by an associated text and an image. Accordingly, the said apparatus comprises a processor module and a selection module. The processor module is adapted to: perform a search on the microblogs based on the associated text to obtain a first set of results (i.e. the text-based results [symbol] ^{t}); perform image detection on the first set of results based on the associated image to obtain a set of seed messages (i.e. the seed microblogs); and perform a search on the microblogs based on a set of characteristics derived from the seed messages to obtain a second set of results (i.e. collectively the social context-based results [symbol] ^{c} and visual content-based results [symbol] ^{ν}). On the other hand, the selection module selects entries from the first and second sets of results based on relevancy to the entity, in which the set of characteristics are associated to the entity.

### 2. The Brand-Social-Net Dataset

In this section, a dataset of microblogs (i.e. Brand-Social-Net) with brand information used for performance evaluation of the proposed method 100 is discussed.

### 2.1 Dataset

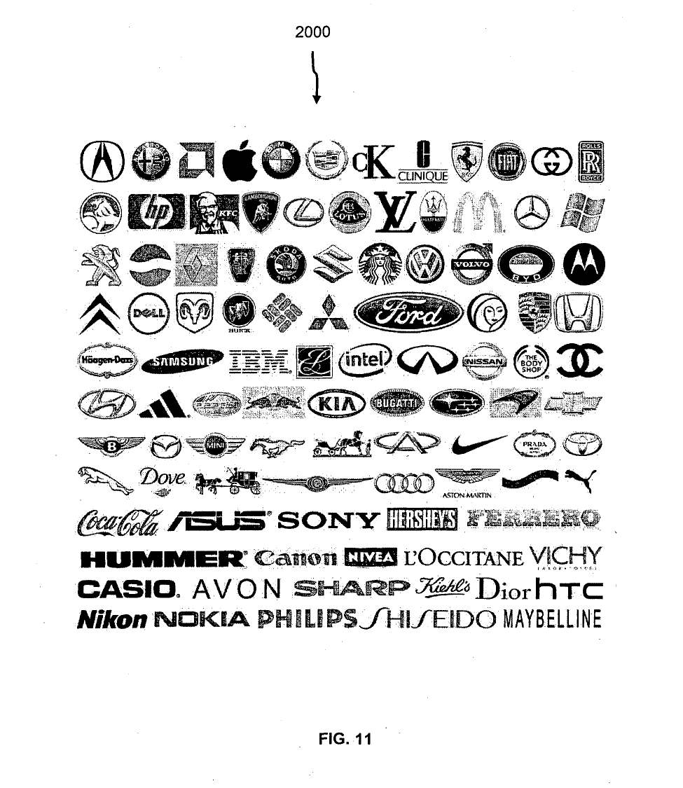

The said dataset was collected from Sina Weibo™ between June and July of 2012 and consists of 3 million microblogs with 1.2 million images. Each microblog contains a text description, at least an image (if available), associated information about the author of the microblog, posting time of the microblog, geo-location from which the microblog is posted, and user connections associated with the author on Sina Weibo™. As shown in the diagram 2000 of FIG. 11, the dataset includes logos of 100 famous brands and 300 different products, which are selected from automobile, sports, electronic products, and cosmetics domains. Also, there are about a total of 1 million individual users (relating to the 3 million microblogs) in the dataset.

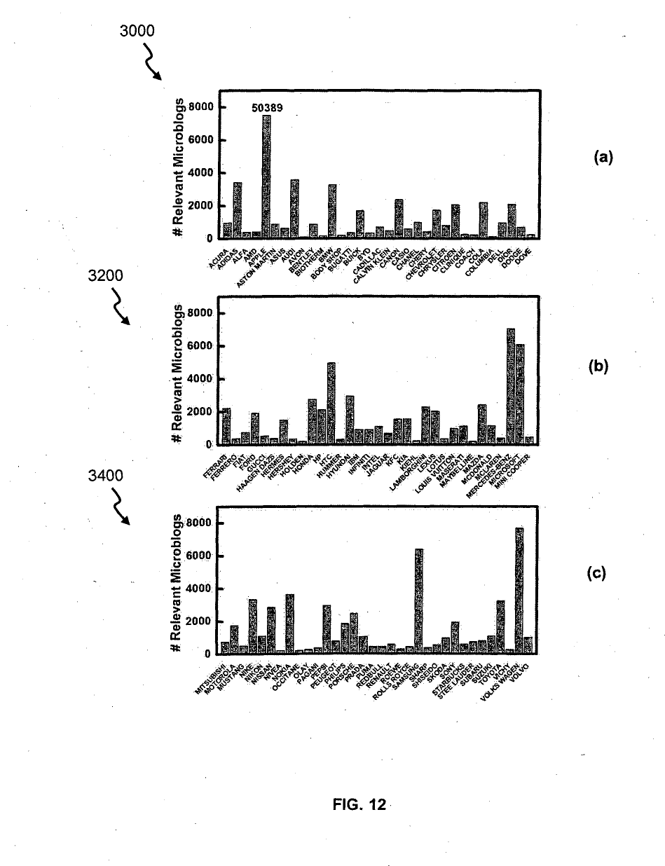

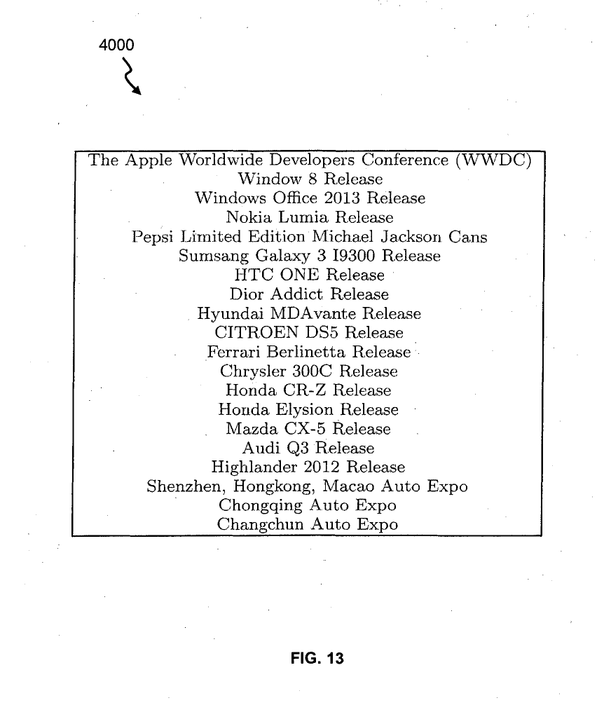

For the said 100 famous brands, a number of relevant microblogs ranges from 122 to 50389, and associated metrics for distributions of the relevant microblogs for each brand are shown in tables 3000, 3200, 3400 of FIGS. 12a to 12c. It is to be appreciated that there are 20 brand/product-related events that resulted in the generation of data as collected in the dataset, and those events occurred between June and July of 2012, of which the specific details of the events are shown in the table 4000 of FIG. 13.

### 2.2 Reference Annotations

The dataset includes ground-truth on the relevance of each microblog to the 100 brands in terms of text description/image(s), as well as positions of objects/products/logos in each image. Each microblog is annotated by three volunteers, and majority voting is employed to determine the final annotations assigned.
Logo annotation. For each image, a bounding box is used to identify an exact location of a logo, if present.
Brand relevance annotation. For each microblog, relevance of the text description and the image (if available) for each brand is annotated separately as 1 and 0.
a) The text description is annotated as Brₜ=1 if the associated content is determined relevant to a target brand; otherwise Brₜ=0.
b) The image is annotated as Brᵢ=1 if the associated content is determined relevant to a target brand; otherwise Brᵢ=0.
c) The microblog is annotated as Br=1 if either the content of the text description or the image is relevant to a target brand; otherwise Br=0.
Product relevance annotation. For each microblog, relevance of the text description and the image (if available) to each product is annotated separately as 1 and 0.
a) The text description is annotated as Prₜ=1 if the associated content is determined relevant to a target product; otherwise Prₜ=0
b) The image is annotated as Prᵢ=1 if the associated content is determined relevant to a target product; otherwise Prᵢ=0.
c) The microblog is again annotated as Pr=1 if either the content of the text description or the image is relevant to a target product; otherwise Pr=0.
Object annotation. If there are relevant objects to a given brand or product, the bounding boxes of these objects are labelled.

### 2.3 Challenging Tasks

For completeness, it is to be appreciated that challenging tasks performable on the dataset include, but not limited to, the following:
Logo/Product/Brand detection and search task. As explained, the dataset includes logos of 100 famous brands and 300 different products, with the annotated ground-truth on the positions of logos/products and relevant objects. The present task may be performed using text, visual, social and/or combination of all features.
Brand/Product data gathering task. One key challenge with obtaining information from social media platforms is how to gather representative sets of data related to a brand or product.
Social event analysis task. Over 20 brand-related events are defined for event detection and tracking research.
Social media related research. The dataset includes social information to support research on sentiment analysis, social network analysis, key users and hot tweets/events analysis and etc.

### 3. Experimental Evaluation

To evaluate the performance of the proposed method 100 in respect of social media streams, experiments based on the Brand-Social-Net dataset are conducted. The experimental settings and result evaluations are discussed in this section.

### 3.1 Experimental Settings

In the experiments, a brand is selected and the objective is to gather all microblogs (i.e. Br=1) in the Brand-Social-Net dataset that are relevant to the selected brand. The recall value is employed to evaluate the data coverage of the relevant microblogs gathered, and the Normalized Discounted Cumulative Gain (NDCG) [10] is used to measure performance of the noisy data filtering method 700. The trade-off parameter λ in equation (4) is set to a value of 0.9. A number of selected images nᵢ is set to a value of 100, and a maximal number of returned images are set to a value of 10000 in the experiments. For the image detection method 300, the average precision and recall are 0.743 and 0.383 respectively. Since results obtained from the image detection are to be regarded as positive sample images for estimation of microblog image relevance, precision is thus an important criterion for further processing. A lower precision for image detection (of a logo) indicates more falsely detected results leading to wrongly labelled samples for subsequent procedures. Thus a higher precision for the image detection ensures that the selected images are highly related to the selected brand.

### 3.2 on Data Coverage of Different Gathering Methods

Discussions on evaluation of data coverage of different (data) gathering methods are provided here. For data gathering with respect to the selected brand, coverage is regarded as an important-performance indicator. A higher coverage leads to more useful content for further analysis. In the experiments, three different types of data resources are utilised: the text-based results [symbol] ^{t}, the social context-based results [symbol] ^{c}, and the visual content-based results [symbol] ^{ν}. Accordingly, the different said gathering methods being evaluated are: (1). A baseline method which relies only on the text-based results [symbol] ^{t}, (2). A second method which relies on combination of the text-based results [symbol] ^{t}, and social context-based results [symbol] ^{c} (i.e. [symbol] ^{t}+ [symbol] ^{c}), (3). A third method which relies on combination of the text-based results [symbol] ^{t}, and visual content-based results [symbol] ^{ν} (i.e. [symbol] ^{t}+ [symbol] ^{ν}), and (4). The proposed method 100 of FIG. 1 which relies on the text-based results [symbol] ^{t}, the social context-based results [symbol] ^{c}, and the visual content-based results [symbol] ^{ν} (i.e. [symbol] ^{t}+ [symbol] ^{c}+ [symbol] ^{ν}).

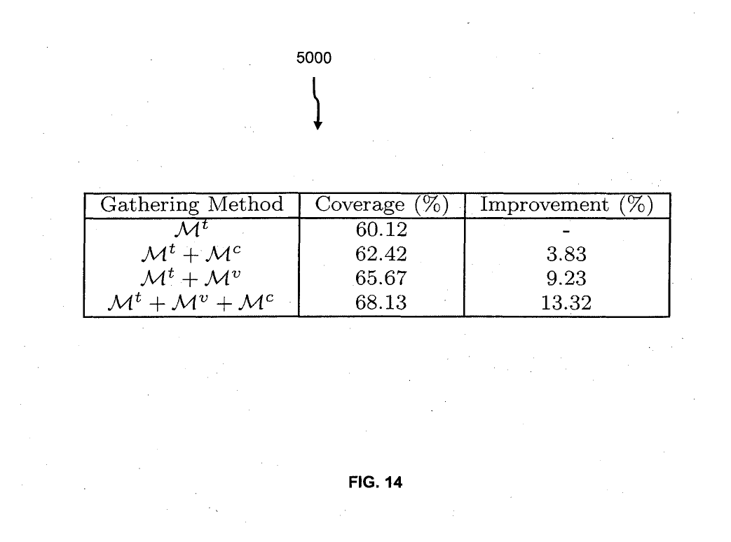

The overall data coverage of the different gathering methods is first evaluated. As shown in the table 5000 of FIG. 14, the baseline method is able to achieve a coverage of 60.12%, which is obtained by determining whether any keywords are present in the text description of the microblogs (of the dataset). By utilizing extended data gathering based on social context, visual content and both, the coverage is improved to 62.42%, 65.67% and 68.13% respectively for the second method, the third method and the proposed method 100. Overall, use of extended data gathering thus leads to a 13.32% improvement in data coverage for the proposed method 100 as compared to the baseline method.

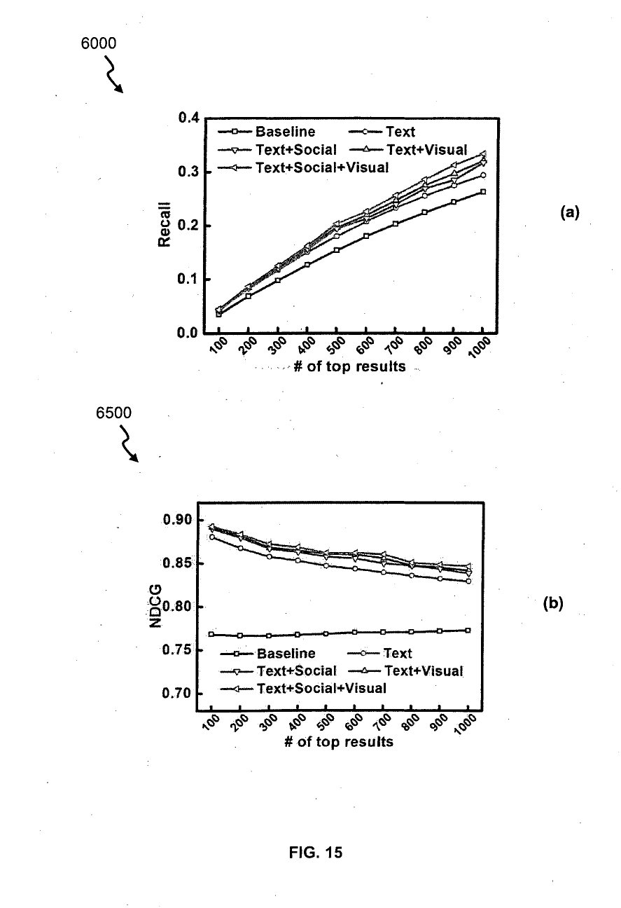

The data coverage of top returned results for the different gathering methods is also evaluated, in which the data coverage of top 100 to 1000 results gathered are compared and shown in the graph 6000 of FIG. 15a. It can be seen that the proposed method 100 is able to achieve a significant gain in the coverage of top returned results compared to the baseline method. By including the social context-based results [symbol] ^{c}, the second method is able to obtain an improvement of 22.90%, 22.72%, 22.80%, 23.36%, 26.21%, and 20.60% for the recall depth of 100, 200, 300, 400, 500, and 1000 respectively, compared to baseline method. Then by including the visual content-based results [symbol] ^{ν}, the third method is able to obtain an improvement of 24.35%, 23.30%, 25.87%, 25.73%, 27.51%, and 21.96% respectively compared to the baseline method. On the other hand, the proposed method 100 is able to obtain an improvement of 27.82%, 26.81%, 27.92%, 28.10%, 32.07%, and 26.90% for the recall depth of 100, 200, 300, 400, 500, and 1000 respectively compared to the baseline method. Hence, the results for the proposed method 100 demonstrate the effectiveness of extended data gathering for brand data gathering in social media streams.

### 3.3 on the Noisy Data Filtering Method

In this section, performance of the noisy data filtering method 700 is evaluated. It is to be appreciated that when multi-resources are employed through the extended data gathering, although higher data coverage of relevant data is achieved, more noisy data are however also obtained during the process. Therefore, noisy data filtering is essential to gather and obtain more relevant results. To evaluate the performance of the noisy data filtering method 700, the NDCG values of top returned results are calculated to compare the different gathering methods. The graph 6500 of FIG. 15b illustrates a comparison of all the different gathering methods in this aspect, and as depicted, the proposed method 100 relying on multi-faceted data resources is able to achieve better accuracy in the top results compared to the baseline method. It is to be noted that the proposed method 100 achieves an improvement of 16.18%, 15.24%, 13.81%, 13.15%, 12.21%, and 9.59% versus the baseline method in terms of NDCG values at respective depths of 100, 200, 300, 400, 500, and 1000.

### 4. Summary

In summary, a huge amount of real-time information generated on social media streams has led to high requirement for brand tracking technologies. To address this challenging task, the method 100 of FIG. 1 is proposed to gather representative data to an entity (e.g. a brand) from large scale social media content. The proposed method 100 gathers relevant data based on evolving keywords, social factors (e.g. users, relations and locations) as well as visual contents since an increasing amount of social media posts also include multimedia contents. For the proposed method 100, the heterogeneous nature of data of social media content are used to advantage, in which the set of seed microblogs are first obtained and then the social context and visual content of the seed microblogs are leveraged to gather more related posts from large scale noisy data. At the noise filtering stage 108, noise filtering is employed to filter and remove the noisy data in the returned results. It is to be appreciated that the proposed method 100 has been evaluated on the Brand-Social-Net dataset, which contains 3 million microblogs with 100 famous brands. Experiments using the said dataset demonstrate that the proposed method 100 is consistently able to achieve better performance compared to existing state-of-the-art methods.

At least two industrial applications for the proposed method 100 are envisaged:

(1). The proposed method 100 may offer improved brand/product searching for live social media platforms compared to conventional methods. Besides text information, images associated with microblogs are also considered to provide another means to locate pertinent information related/relevant to a brand/product of interest, and as a result, more useful information may be obtained. In addition, as the obtained results are ranked in order of relevance to the brand/product of interest, they may be displayed in a clear manner for easy viewing by users.

(2). The proposed method 100 may serve as a useful tool for enterprises/organisations to determine how well a specific brand/product is received in public by analysing discussions across different social media platforms. Through the method 100, valuable statistics and user feedbacks may be obtained to assist with the determination and any analysis (if required). Microblogs mentioning/discussing the specific brand/product may easily be collected for further processing. Also, the enterprises/organisations are then able to monitor how often the specific brand/product is mentioned and perceived by consumers/users, and consequently allowing for further analysis of the popularity and reputation of the specific brand/product. Moreover, the proposed method 100 can also be used to carry out competitive analysis against competing brands/products by gathering related social exposure statistics relating to those competing brands/products.

For completeness, it is highlighted that to address the issue of more accurately harvesting relevant data from social media platforms, there are still several future tasks ahead. Firstly, a task of how to extract visual context for target objects is an important issue, because the target objects may not explicitly appear in the visual content, while the visual context should implicitly help to uncover relevant visual content. Secondly, a task of how to learn relevant social context from both a small seed set and a large data collection is important in gathering more relevant data and filtering noisy data. Thirdly, the noisy data filtering method 700 incurs expensive computational costs, and so an improved data filtering algorithm (in terms of effectiveness and efficiency) is required for dealing with large scale live data.

The described embodiments should not however be construed as limitative. For example, the following categories of users may also be included as key users (afore discussed in section 1.3.1.1) for extended data gathering via using social context: (1). users who are socially connected to the authors of microblogs in the seed set, (2). authors of associated reposts of relevant/related microblogs and have commented on those microblogs, (3). a second group of key users of the target brand, (4). users who are connected to the second group of key users, (5). similar users of the authors of microblogs in the seed set. It is clarified that the second group of key users are defined as users whose names include keywords associated with the target brand. For example, a high percentage of the second group of key users may include the target brand's official representatives or appointed vendors. Hence, microblogs posted by the second group of key users are also likely relevant/related to the target brand. With reference to the similar users, similarity is defined by comparing contents of microblogs posted by users (during a predetermined time period being assessed) with the seed microblogs. In this regard, the microblogs obtained from various social media streams are searched with respect to each author of the seed microblogs, and the top ten most similar users (to each author of the seed microblogs) are stored as the similar users. It should also be appreciated that the proposed method 100 may also be executed to concurrently search a plurality of designated datasets of microblogs to locate relevant/related information to a target entity.

Another variation pertains to the extended data gathering by using visual content described in section 1.3.2. Specifically, to retrieve similar images given a provided image, there are three procedures: (1). feature extraction, (2). feature indexing, and (3). searching. Each image to be compared is depicted as a feature vector which includes multiple local feature vectors. To extract local features, interest points corresponding to some small regions in the associated image are located, and there are two ways to locate the interest points. The first way is to use interest point detectors arranged to detect image regions satisfying certain mathematical conditions, which may be performed via (for example) Harris corner detection method, FAST [35], SIFT [30], or SURF [32]. The second way is to regularly divide the said image into small overlapped or non-overlapped regions and each image region represents an interest point. In addition, to account for size invariance, the said image is resized into different scales and interest points are extracted at each scale.

Once the interest points are obtained, a next step is to use a feature descriptor to extract feature(s) describing each interest point. The feature descriptor may be, for example, SIFT [30], PCA-SIFT [31], SURF [32], ORB [33] or BRIEF [34]. Once completed, a further step is to perform image indexing, and a Hashing technique may be employed, for example, Spectral Hash or Locality Sensitive Hashing. In using the Hashing technique, a high dimensional feature vector is encoded into a low dimensional code, for example, a 32-bit code. At a search phase, the provided image is encoded into a hashing code based on the above two steps. To find similar images in microblogs being investigated, a distance to each image in the microblogs is calculated using very low dimensional data, which may then be quickly processed. For example, a top 10 microblogs with most similar images are returned for each image in the seed set.

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

### REFERENCES

[1]. J. Bu, S. Tan, C. Chen, C. Wang, H. Wu, L. Zhang, and X. He. Music recommendation by unified hypergraph: combining social media information and music content. In Proceedings of MM, 2010.
[2]. C. Chen, F. Li, B. C. Ooi, and S. Wu. Ti: an efficient indexing mechanism for real-time search on tweets. In Proceedings of the 2011 international conference on Management of data, pages 649-660, 2011.
[3]. N. Dalai and B. Triggs. Histograms of oriented gradients for human detection. In Proceedings of IEEE Conference on Computer Vision and Pattern Recognition, pages 886-893, 2005.
[4]. M. Efron. Information search and retrieval in microblogs. Journal of the American Society for Information Science and Technology, 62(6):996-1008, 2011
[5]. Y. Gao, M. Wang, D. Tao, R. Ji, and Q. Dai. 3D object retrieval and recognition with hypergraph analysis. IEEE Transactions on Image Processing, 21(9):4290-4303, 2012.
[6]. Y. Gao, M. Wang, Z. Zha, J. Shen, X. Li, and X. Wu. Visual-textual joint relevance learning for tag-based social image search. IEEE Transactions on Image Processing, 22(1):363-376, 2013.
[7]. S. Gaonkar, J. Li, R. R. Choudhury, L. Cox, and A. Schmidt. Micro-blog: sharing and querying content through mobile phones and social participation. In Proceedings of the international conference on Mobile systems, applications, and services, pages 174-186, 2008.
[8]. C. Gu and S. Wang. Empirical study on social media marketing based on sina microblog. In International Conference on Business Computing and Global Informatization, pages 537-540, 2012.
[9]. Y. Huang, Q. Liu, S. Zhang, and D. Metaxas. Image retrieval via probabilistic hypergraph ranking. In Proceedings of IEEE Conference on Computer Vision and Pattern Recognition, 2010.
[10]. K. Jarvelin and J. Kekalainen. Cumulated gain-based evaluation of it techniques. ACM Transactions on Information Systems, 20(4):422-466, 2002.
[11]. C. H. Leung, A. W. Chan, A. Milani, J. Liu, and Y. Li. Intelligent social media indexing and sharing using an adaptive indexing search engine. ACM Transactions on Intelligent Systems and Technology (TIST), 3(3):47, 2012.
[12]. G. Li, J. Cao, J. Jiang, Q. Li, and L. Yao. Brand tweets: How to popularize the enterprise micro-blogs. In IEEE International Information Technology and Artificial Intelligence Conference, volume 1, pages 136-139, 2011.
[13]. K. Massoudi, M. Tsagkias, M. de Rijke, and W. Weerkamp. Incorporating query expansion and quality indicators in searching microblog posts. Advances in Information Retrieval, pages 362-367, 2011.
[14]. R. Nagmoti, A. Teredesai, M. De Cock, et al. Ranking approaches for microblog search. In IEEE/WIC/ACM International Conference on Web Intelligence and Intelligent Agent Technology, 2010.
[15]. N. Naveed, T. Gottron, J. Kunegis, and A. C. Alhadi. Searching microblogs: coping with sparsity and document quality. In Proceedings of CIKM, pages 183-188, 2011.
[16]. B. O'Connor, M. Krieger, and D. Ahn. Tweetmotif: Exploratory search and topic summarization for twitter. In Proceedings of the Fourth International AAAI Conference on Weblogs and Social Media, 2010.
[17]. T. Rowlands, D. Hawking, and R. Sankaranarayana. New-web search with microblog annotations. In Proceedings of WWW, pages 1293-1296. ACM 2010.
[18]. T. Sakaki, M. Okazaki, and Y. Matsuo. Earthquake shakes twitter users: real-time event detection by social sensors. In Proceedings of the 19th international conference on World wide web, pages 851-860, 2010.
[19]. M. Steinbach, G. Karypis, and V. Kumar. A comparison of document clustering techniques. In Proceedings of KDD Workshop on Text Mining, 2000.
[20]. Y. Sui and X. Yang. The potential marketing power of microblog. In International Conference on Communication Systems, Networks and Applications, volume 1, pages 164-167, 2010.
[21]. J. Teevan, D. Ramage, and M. R. Morris. # twittersearch: a comparison of microblog search and web search. In Proceedings of the fourth ACM international conference on Web search and data mining, pages 35-44, 2011.
[22]. P. Viola and M. J. Jones. Robust real-time face detection. International journal of computer vision, 57(2):137-154, 2004.
[23]. W. Weerkamp and M. De Rijke. Credibility improves topical blog post retrieval. Association for Computational Linguistics (ACL), 2008.
[24]. Y. Weiss, A. Torralba, and R. Fergus. Spectral hashing. NIPS, 2008.
[25]. J. Yang, K. Yu, Y. Gong, and T. Huang. Linear spatial pyramid matching using sparse coding for image classification. In Proceedings of IEEE Conference on Computer Vision and Pattern Recognition, pages 1794-1801, 2009.
[26]. D. Zhou, J. Huang, and B. Schokopf. Learning with hypergraphs: Clustering, classification, and embedding. In Proceedings of NIPS, 2007.
[27]. D. Zhou, S. Lawless, and V. Wade. Improving search via personalized query expansion using social media. Information retrieval, 15(3-4):218-242, 2012.
[28]. Wang, Xiaoyu, Tony X. Han, and Shuicheng Yan. “An HOG-LBP human detector with partial occlusion handling.” Computer Vision, 2009 IEEE 12th International Conference on. IEEE, 2009.
[29]. Gall, Juergen, and Victor Lempitsky. “Class-specific hough forests for object detection.” Decision Forests for Computer Vision and Medical Image Analysis. Springer London, 2013. 143-157.
[30]. Lowe, David G. “Distinctive image features from scale-invariant keypoints.” International journal of computer vision 60.2 (2004): 91-110.
[31]. Ke, Yan, and Rahul Sukthankar. “PCA-SIFT: A more distinctive representation for local image descriptors.” Computer Vision and Pattern Recognition, 2004. CVPR 2004. Proceedings of the 2004 IEEE Computer Society Conference on. Vol. 2. IEEE, 2004.
[32]. Bay, Herbert, Tinne Tuytelaars, and Luc Van Gool. “Surf: Speeded up robust features.” Computer Vision-ECCV 2006. Springer Berlin Heidelberg, 2006. 404-417.
[33]. Rublee, Ethan, et al. “ORB: an efficient alternative to SIFT or SURF.” Computer Vision (ICCV), 2011 IEEE International Conference on. IEEE, 2011.
[34]. Calonder, Michael, et al. “BRIEF: binary robust independent elementary features.” Computer Vision-ECCV 2010. Springer Berlin Heidelberg, 2010. 778-792.
[35]. Rosten, Edward, and Tom Drummond. “Machine learning for high-speed corner detection.” Computer Vision-ECCV 2006. Springer Berlin Heidelberg, 2006. 430-443.

1. A method of tracking microblog messages for relevancy to an entity identifiable by an associated text and an image, the method comprises:
(i) performing a search on the microblog messages based on the associated text to obtain a first set of results;
(ii) performing image detection on the first set of results based on the associated image to obtain a set of seed messages;
(iii) performing a search on the microblog messages based on a set of characteristics derived from the seed messages to obtain a second set of results; and
(iv) selecting entries from the first and second sets of results based on relevancy to the entity,
wherein the set of characteristics are associated to the entity.

2. The method of claim 1, wherein the entity includes a brand or a product.

3. The method of claim 1, wherein performing the image detection includes:
(i) dividing each image obtained from the first set of results into a plurality of sub-windows, and
(ii) performing a sliding window search on the plurality of sub-windows to determine if the said image corresponds to the image associated with the entity.

4. The method of claim 1, wherein the set of characteristics include social context-based data and image-based data.

5. The method of claim 4, wherein the second set of results includes respective sets of results obtained based on the social context-based data and the image-based data.

6. The method of claim 4, wherein the social context-based data include information related to authors of the seed messages, users associated with the seed messages or the authors of the seed messages, users who have commented on the seed messages, users with corresponding user identities having the associated text, and geographical locations from where the seed messages were posted.

7. The method of claim 1, wherein performing the search on the microblog messages includes performing a text-based search using the associated text.

8. The method of claim 1, wherein selecting entries from the first and second sets of results includes:
(i) constructing a hypergraph to determine correlations among microblog messages in the first and second sets of results to obtained associated correlation results;
(ii) determining respective scores for said microblog messages based on the correlation results; and
(iii) ranking said microblog messages based on the respective scores.

9. An apparatus for tracking microblog messages for relevancy to an entity identifiable by an associated text and an image, the apparatus comprising:
a processor module adapted to:
perform a search on the microblog messages based on the associated text to obtain a first set of results;
perform image detection on the first set of results based on the associated image to obtain a set of seed messages; and
perform a search on the microblog messages based on a set of characteristics derived from the seed messages to obtain a second set of results; and
a selection module for selecting entries from the first and second sets of results based on relevancy to the entity,
wherein the set of characteristics are associated to the entity.
